(19) United States
(12) Patent Application Publication
(10) Pub. No.: US 2018/0276765 A1
(43) Pub. Date: Sep. 27, 2018

(54) COMPUTERISED SYSTEM AND METHOD FOR COLLABORATIVE PUBLISHING

(71) Applicant: PAPERFLY LIMITED, KWUN TONG, KOWLOON (CN)

(72) Inventor: Timothy YUEN, Hong Kong (CN)

(73) Assignee: PAPERFLY LIMITED, KWUN TONG, KOWLOON (CN)

(21) Appl. No.: 15/763,443

(22) PCT Filed: Apr. 6, 2017
(86) PCT No.: PCT/CN2017/079586

§ 371 Date: Mar. 27, 2018

(30) Foreign Application Priority Data
Apr. 7, 2016 (HK) 16104000.2

(51) Int. Cl. G06Q 40/00; G06F 3/0482; G06F 3/0483; G06Q 30/02

(52) U.S. Cl. CPC G06Q 40/125; G06Q 30/0257; G06F 3/0483; G06F 3/0482

(57) ABSTRACT

A method of providing page content options for user-selection to personalise pages of a publication for digital printing, the method being operable using a computerised system, and the method including the steps of: (i) prescribing parameters for page content associated with pages of the publication to be digitally printed; (ii) communicating the prescribed page content parameters to a plurality of content contributors; and (iii) receiving page content produced by the plurality of content contributors in response to the prescribed parameters communicated thereto; wherein, the received page content produced by the plurality of content contributors is able to be presented as page content options for user-selection to personalise pages of the publication for digital printing.

### TECHNICAL FIELD d

The present invention relates to bespoke publishing particularly in the field of digital printing systems and technologies.

### BACKGROUND OF THE INVENTION

Digital printing services are used to print books and other publications using digital printing technologies and provide certain advantages over offset printing technologies and systems in the context of bespoke and personalised print runs where the gross costs of production, including inventory and inventory written off, may be lower.

Even with the relatively lower gross costs associated with short run bespoke printing utilising digital printing technologies in comparison to the use of offset printing, the adoption of digital printing systems and technologies as a monetisable business model in the context of bespoke publishing has been under-utilised for various reasons. Firstly, the back-end pre-printing costs to produce the bespoke publication is still relatively expensive due to the overhead costs associated with hiring of a staff contributor (e.g. a writer, graphic artist etc) to produce the bespoke content, as well as the cost of hiring editorial staff to edit, and, design staff to layout, process and check the that the content produced by staff contributors is of suitable quality. Secondly, the demand for bespoke or personalised publications is perceived to be under-utilised and under-monetised because under the conventional bespoke publication paradigm, the production of bespoke content by a staff contributor is a relatively slow and time-consuming process and also, the variety and diversity of content that is produced for availability to customers is perceived to be limited.

Another perceived problem associated with certain publications, for instance illustrated story books for children, is that the language, content and format of the text contained in the pages of the illustrated story book tend to be fixed making such illustrated story books of limited relevance to children falling within a certain age group and within a specific language background. A child having an age and language profile that is incompatible with the text of the illustrated story book will not be able to comprehend and learn from the illustrated story book. It is generally not feasible to modify such illustrated story books for small-scale print runs as the cost of purchasing copyright license tends to outweigh the ultimate value in generating the customised edition of the illustrated story book.

### SUMMARY OF THE INVENTION

The present invention seeks to alleviate at least one of the above-described problems.

The present invention may involve several broad forms. Embodiments of the present invention may include one or any combination of the different broad forms herein described.

In a first broad form, the present invention provides a method of providing page content options for user-selection to personalise pages of a publication for digital printing, the method being operable using a computerised system, and the method including the steps of:

(i) prescribing parameters for page content associated with pages of the publication to be digitally printed;

(ii) communicating the prescribed page content parameters to a plurality of content contributors; and

(iii) receiving page content produced by the plurality of content contributors in response to the prescribed parameters communicated thereto;

wherein, the received page content produced by the plurality of content contributors is able to be presented as page content options for user-selection to personalise the pages of the publication for digital printing.

Preferably, the plurality of content contributors may comprise freelance content contributors.

Preferably, the present invention may include a step of providing an online interactive menu interface via which a user is able to select form the page content options to personalise pages of the publication to be digitally published.

Preferably, the publication may include an educational publication and the page content associated with pages of the publication may include at least one of an essay, a case study, lecture notes, learning exercises and an assessment.

Preferably, the prescribed parameters of the page content associated with the pages of the publication may include a learning objective of the at least one of the essay, the case study, the lecture notes, the learning exercises and the assessment included on each page.

Preferably, when a page content option is selected for inclusion as page content of a page of the publication, the content contributor that produced the selected page content option may be attributed on the page of the publication.

Preferably, when a page content option is selected for inclusion as page content of a page of the publication, the content contributor that produced the selected page content option may be rewarded with a royalty.

Preferably, the present invention may include a step of assessing whether page content produced by the plurality of content contributors meets a predetermined screening criteria before presenting the page content option for user-selection.

Preferably, the present invention may include a step of including targeted advertising in the publication to be digitally printed, the targeted advertising selected for inclusion in the publication by reference to the page content options selected by the user.

In a further broad form, the present invention provides a computerised system for use in providing page content options for user-selection to personalise pages of a publication for digital printing, the computerised system being configured for:

(i) prescribing parameters for page content associated with pages of the publication to be digitally printed;

(ii) communicating the prescribed page content parameters to a plurality of content contributors; and

(iii) receiving page content produced by the plurality of content contributors in response to the prescribed parameters communicated thereto;

wherein, the received page content produced by the plurality of content contributors is able to be presented as page content options for user-selection to personalise pages of the publication for digital printing.

Preferably, the plurality of content contributors may comprise freelance content contributors.

Preferably, the present invention may be configured for providing an online interactive menu interface via which a user is able to select form the page content options to personalise pages of the publication to be digitally published.

Preferably, the publication may include an educational publication and the page content associated with pages of the publication may include at least one of an essay, a case study, lecture notes, learning exercises and an assessment

Preferably, the prescribed parameters of the page content associated with the pages of the publication may include a learning objective of the at least one of the essay, the case study, the lecture notes, the learning exercises and the assessment included on each page.

Preferably, when a page content option is selected for inclusion as page content of a page of the publication, the content contributor that produced the selected page content option may be attributed on the page of the publication.

Preferably, when a page content option is selected for inclusion as page content of a page of the publication, the content contributor that produced the selected page content option may be rewarded with a royalty.

Preferably, the present invention may be configured to assess whether page content produced by the plurality of content contributors meets a predetermined screening criteria before presenting the page content option for user-selection.

Preferably, the present invention is configured to include targeted advertising in the publication to be digitally printed, the targeted advertising being selected for inclusion in the publication by reference to the page content options selected by the user.

In a further broad form, the present invention provides a method of customising page content of at least one page of a publication for digital printing, the method being operable using a computerised system comprising a user profile module and a page content module, the method including the steps of: (i) the user profile module obtaining a user profile comprising information indicative of at least one characteristic of a target user of the publication; and (ii) the page content module associating a page content with at least one page of the publication by reference to the obtained user profile; whereby the at least one page of the publication is configured to display the page content associated therewith when digitally printed.

Preferably, the information indicative of the at least one characteristic of the target user may include at least one of an age, a gender, a sexuality, a language ability, a literacy ability, geographic location, an ethnicity, a nationality, a socio-economic status, a religious affiliation, a sporting affiliation, a political affiliation, an educational institution affiliation, an occupation, a health status, and a consumer purchase behaviour of the target user.

Preferably, the information indicative of the at least one characteristic of the target user comprising the user profile may be accessible by the user profile module via at least one of: (i) an input interface configured for receiving the information indicative of the at least one characteristic of the target user in to the computerised system; and (ii) a data store of the computerised system configured for storing the information indicative of the at least one characteristic of the target user.

Preferably, the page content associated with the at least one page of the publication may be accessible by the page content module via at least one of: (i) an input interface configured for receiving information indicative of the page content in to the computerised system; and (ii) a data store of the computerised system configured for storing the page content therein.

Preferably, the page content module may be configured for selecting a page content from amongst a plurality of predefined page contents for association with the at least one page of the publication, whereby the selected page content may be selected by reference to the obtained user profile matching at least one of a vocabulary type, a word count, a grammatical pattern, a font type, a font size, a font colour, and a language type, of the selected page content, in accordance with the matching algorithm.

Preferably, the computerised system may include a page layout module and the method includes a further step (iii) of the page layout module associating a page layout with the page content on the at least one page of the publication.

Preferably, step (iii) may include the page layout module associating a predefined page layout from amongst a plurality of predefined page layouts with the page content on the at least one page of the publication in accordance with at least one of (i) a matching algorithm, and, (ii) manual selection.

Preferably, the at least one page of the publication may include a fixed page content associated therewith, and wherein the page layout associated with the at least one page of the publication by the page layout module may be configured for arranging the page content associated with the at least one page of the publication by the page content module relative to the fixed page content on the at least one page of the publication.

Preferably, the fixed page content may include an image or graphics-based page content and the page content associated with the at least one page of the publication by the page content module may include a text-based page content.

Preferably, the present invention may include a page sequence module configured for controlling the sequence of the pages of the publication.

Preferably, information indicative of the at least one page of the publication, the page content, and page layout associated therewith may be stored in a data store of the page content module, whereby said information may be able to be accessed via the computerised system for re-use as a predefined page of another publication for digital printing.

In a further broad form, the present invention provides a system for customising page content of at least one page of a publication for digital printing, the method being operable using a computerised system comprising a user profile module and a page content module, wherein: (i) the user profile module is configured for obtaining a user profile comprising information indicative of at least one characteristic of a target user of the publication; and (ii) the page content module is configured for associating a page content with at least one page of the publication by reference to the obtained user profile; whereby the at least one page of the publication is configured to display the page content associated therewith when digitally printed.

Preferably, the information indicative of the at least one characteristic of the target user may include at least one of an age, a gender, a sexuality, a language ability, a literacy ability, geographic location, an ethnicity, a nationality, a socio-economic status, a religious affiliation, a sporting affiliation, a political affiliation, an educational institution affiliation, an occupation, a health status, and a consumer purchase behaviour of the target user.

Preferably, the information indicative of the at least one characteristic of the target user comprising the user profile may be accessible by the user profile module via at least one of: (i) an input interface configured for receiving the information indicative of the at least one characteristic of the target user in to the computerised system; and (ii) a data store of the computerised system configured for storing the information indicative of the at least one characteristic of the target user.

Preferably, the page content module may be configured for accessing the page content associated with the at least one page of the publication via at least one of: (i) an input interface configured for receiving information indicative of the page content in to the computerised system; and (ii) a data store of the computerised system configured for storing the page content therein.

Preferably, the page content module may be configured for associating the page content with the at least one page of the publication by reference to the user profile, in accordance with a matching algorithm.

Preferably, the page content module may be configured for selecting a page content from amongst a plurality of predefined page contents for association with the at least one page of the publication, whereby the selected page content may be selected by reference to the obtained user profile matching at least one of a vocabulary type, a word count, a grammatical pattern, a font type, a font size, a font colour, and a language type, of the selected page content, in accordance with the matching algorithm.

Preferably, the computerised system may include a page layout module and whereby the page layout module is configured for associating a page layout with the page content on the at least one page of the publication.

Preferably, the page layout module may be configured for associating a predefined page layout from amongst a plurality of predefined page layouts with the page content on the at least one page of the publication in accordance with at least one of (i) a matching algorithm, and, (ii) manual selection.

Preferably, the at least one page of the publication may include a fixed page content associated therewith, and wherein the page layout associated with the at least one page of the publication by the page layout module may be configured for arranging the page content associated with the at least one page of the publication by the page content module relative to the fixed page content on the at least one page of the publication.

Preferably, the fixed page content may include an image or graphics-based page content and the page content associated with the at least one page of the publication by the page content module may include a text-based page content.

Preferably, the present invention may include a page sequence module configured for controlling the sequence of the pages of the publication.

Preferably, information indicative of the at least one page of the publication, the page content, and page layout associated therewith may be stored in a data store of the page content module, whereby said information is able to be accessed via the computerised system for re-use as a predefined page of another publication for digital printing.

In view of the preceding statements, it is apparent that the broad forms of the present invention may assist in providing at least one of the following advantages over existing systems and technologies:
(a) the novel adoption of this methodology in the context of digitally printed bespoke publications which involves establishing and utilising a network of freelance (“viral”) contributors (e.g. writers, graphic artists etc), allows rapid production of page content options for customers to personalise pages of a publication by virtue of the sharing economy of the network of freelance contributors;
(b) improved diversity and variety of page content options is provided by virtue of establishing and utilising the network of freelance contributors and this assists in improving the attractiveness of bespoke/personalised publication digital printing services to customers;
(c) the traditionally expensive costs associated with back-end pre-printing stage of the production process is alleviated as the utilisation of the network of freelance contributors may be automated and managed which may obviates the costs associated with hiring of dedicated back-end staff contributors, editorial staff and so on;
(d) the bespoke publication having personalised pagination is configured to be digitally printed and delivered to customers in a tangible form which may be considered preferable in particular contexts including educational texts for young children, printed materials for sight-impaired customers, or for instance, printed maps when travelling where access to an online map service is inaccessible;
(e) the ability to customise the page content of a publication, for instance illustrated story books for children, means that variations of such story book publications may be utilised by a broader range of users of varying ages and varying language backgrounds; and
(f) the ability of embodiments of the present invention to automatically associate a predefined page layout for text and graphics page content associated with pages of a publication alleviates the need for use graphic layout software which may be considered difficult and time-consuming to use and operate;
(g) the ease of customising publication of illustrated story books, illustrated text books and the like will assist in maximising learning effectiveness for a target user. Furthermore, as any given illustrated story book of text book is able to be used in multiple customised editions having differentiated text-based page content, any language at any level of sophistication may be published on demand at any time and any location using a digital printer operably connected to the computerised system. Moreover, this embodiment enables re-useage of the same graphical content within an illustrated story book for relatively small-scale print runs.

### BRIEF DESCRIPTION OF THE DRAWINGS

The present invention will become more fully understood from the following detailed description of a preferred but non-limiting embodiments thereof, described in connection with the accompanying drawings, wherein:

FIG. 1 shows a first embodiment of the present invention comprising a central server communicably connected with a plurality of end-user terminals operable by a network of viral contributors to produce and upload page content for customer selection in personalising pages of a publication;

FIG. 2 shows the first embodiment of the present invention comprising a central server communicably connected with a plurality of end-user terminals operable by customers who are able to select page content options produced by the viral contributors in order to personalise pages of the publication to be digitally printed;

FIG. 3 shows a flow chart depicting method steps in accordance with an embodiment of the present invention;

FIG. 4 shows an example screenshot of an interactive user-interface application used to personalise pages of a textbook in accordance with an embodiment of the present invention;

FIG. 5 shows another screenshot of the interactive user-interface application of FIG. 4 and how the user is able to selectably reorder the presentation of the page content in the personalised textbook via the interactive user-interface;

FIG. 6 shows another screenshot of the interactive user-interface application of FIG. 4 and how the user is able to selectably delete page content in the personalised textbook via the interactive user-interface;

FIG. 7 shows an example screenshot of an interactive user-interface application used to personalise pages of a cookbook in accordance with an embodiment of the present invention.

FIG. 8 shows a functional block diagram of a computerised system for customising page content of pages of a publication for digital printing in accordance with a further embodiment of the present invention;

FIG. 9 shows a flow chart of method steps involved in operating the computerised system of FIG. 8 in accordance with an embodiment of the present invention.

FIG. 10A shows an example representation of a page of a publication with a fixed page content (i.e. image (810)) displayed thereon;

FIGS. 10B-10C shows 3 different text page content options which may be selectably associated with the page of the publication shown in FIG. 10A by a page content module in accordance with a matching algorithm by reference to a user profile of the target user of the publication;

FIGS. 11A-11C shows the page of the publication with the fixed page content arranged relative to each of the 3 different types page content options respectively in accordance with a first layout option; and

FIGS. 12A and 12B shows alternate page layouts of the fixed image page content relative to the selected text page content associated with the page of the publication.

### DETAILED DESCRIPTION OF THE PREFERRED EMBODIMENTS

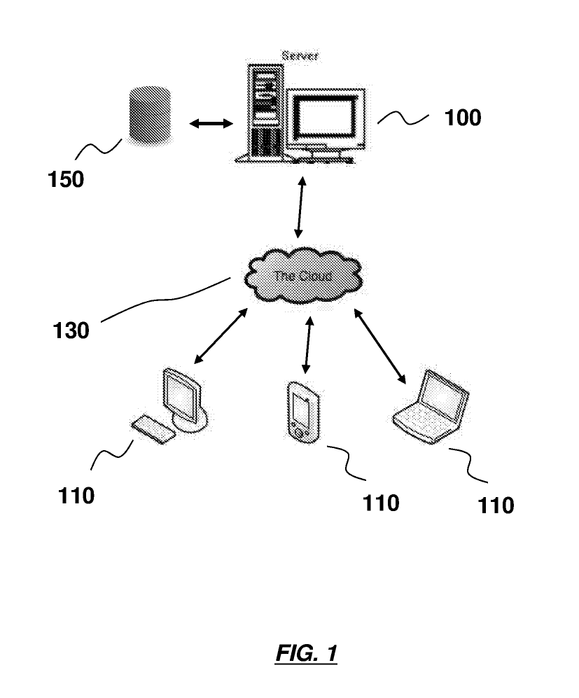

A preferred embodiment of the present invention will now be described with reference to FIGS. 1 to 7 comprising a computerised system which allows customers of a digital printing service to personalise the pages of a digitally printed publication by using an online interactive menu to select desired page content from amongst a range of available page content options. For illustrative purposes, this embodiment will be described in the context of digital printing of an educational publication for use by students in leaning particular subjects such as mathematics, chemistry, physics, English and so on. However, the principles of operation of this system are applicable to other contexts and may for instance be utilised to personalise travel guides, historical/archival publications, maps, musical scores, recipe books, trade catalogues or other texts where a tangible and personalised content may be particularly desirable and valuable to suit the specific tastes, needs and interests of individual users. The ability to personalise these types of publications fills a need in the market where users currently may have little option but to utilise non-personalised generic publications which contain material in excess of the user's specific needs. This can be inconvenient for instance in the context of non-personalised generic travel guides which often contain excessive amounts of information much of which is of no relevance to a traveler but makes it both heavier and more cumbersome to carry about when traveling. Moreover, the amount paid by the user to purchase the non-personalised generic travel guide is reflective not only of the content that the user actually requires, but also the irrelevant content contained therein.

This embodiment comprises two main aspects that will be described in greater detail below, namely (i) a pre-printing stage whereby a novel methodology is utilised in the context of personalised digital printing by employing a network of freelance (or “viral”) content contributors (e.g. a writer, graphic artist etc.) to produce page content that may be presented to customers as page content options to personalise various pages of digitally printed publications; and (ii) a computerised system and online accessible Web site interface which allows customers to personalise the page content for each page of the publication to be digitally printed by selecting page content from the range of page options presented to the customer.

Referring to FIG. 1 a central server (100) is provided which is configured for cross-platform communication with a plurality of end-user terminals (110) via a wired or wireless network which for instance may include the Internet (130). In alternative embodiments the central server may instead be implemented utilising a distributed server architecture. The end-user terminals (110) may include laptop computers, desktop computers, tablet-type computing devices, smartphone devices or any other device suitably configured to be operable by viral contributors for use in creating and uploading content to the central server (100).

Potential viral contributor candidates that wish to contribute page content for potential selection by customers in personalizing their publications are required to initially register their details via an online interactive Web interface hosted by and running on the central server (100). On the Web interface candidates are required to confirm a mandatory level of qualification, professional experience, writing experience and/or any other relevant information to ensure that quality control is maintained. To reduce overhead costs associated with due diligence and the like the candidates may also be required to enter a disclaimer of copyright or other rights to any page content that will be produced by the candidate if registered within the network of vial contributors contributing to the system. Such information and undertakings are able to be readily recorded via the interactive Web interface and stored for later referencing as required and may assist in alleviating overall business administration and due diligence costs. If a candidate does not confirm such mandatory information or agree to mandatory undertakings, then the candidate's registration will not be processed further and a message is communicated to the candidate via the Web site that the registration has failed. If a candidate meets the requirements, then the personal and contact details are stored in a database (150) running on the central server (100) and a confirmation message is communicated to the candidate via email or any other suitable communication medium confirming that they are now eligible to participate in the system.

In this embodiment, a predetermined structured learning plan is prescribed in respect of each educational publication that is to be offered to customers as a personalisable digitally printed publication. The structured learning plan is important in the context of such educational texts as it will define the key concepts, ideas and principles that must be covered in the publication, the manner in which they are to be covered (e.g. by providing informative text such as essays, case studies, lecture notes, and assessments, by way of learning exercises, or any one of these), and, the sequence in which they are covered, amongst other things, so as to be conductive to learning about the topic. The structured learning plan is presented in terms of sub-topics of the overall topic that is being learnt, the number of pages in the publication that will be allocated to each sub-topic, the specific pages of the publication and the sequence in which each sub-topic is to be taught, the type of learning activity that the student will be expected to undertake on each page of the publication. Certain other prescribed parameters for the page content that is required to be produced by viral contributors in respect of a page of the publication include for instance the language of the page content, the word count, the number of learning exercises and/or examples that should be presented, the style and syntax of the content and so on. In these embodiments, the structured learning plan and prescribed parameters are intended to assist viral contributors in quickly understanding and familiarising with the structure and parameters of the content required for the publication so that the viral contributors are able to rapidly and appropriately produce page content for the system based on this guidance provided.

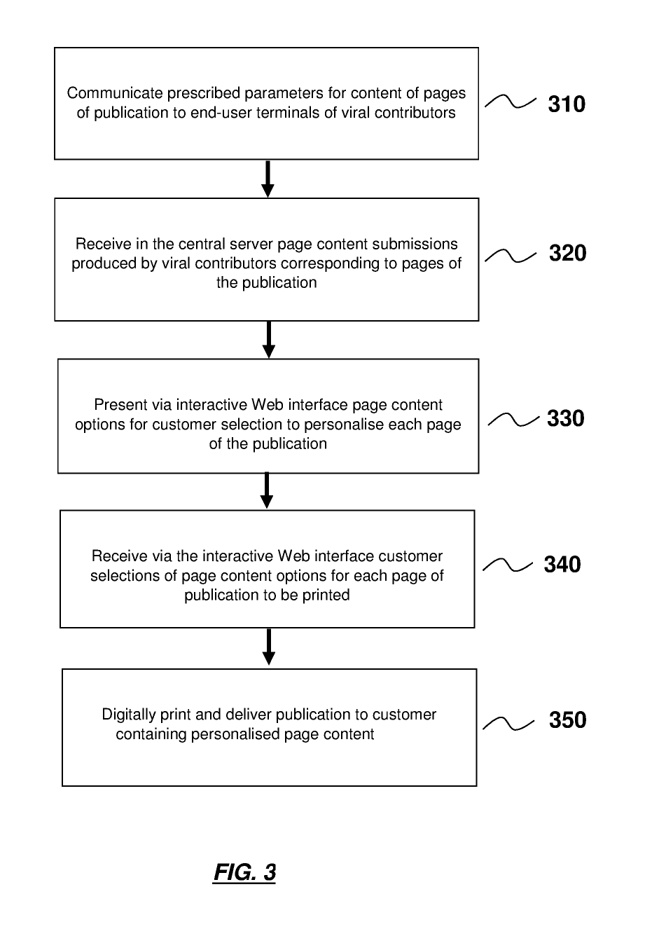

The structured learning plan and prescribed parameters are made accessible to each of the viral contributors. This enables each of the viral contributors to have an understanding and guide to the precise scope and nature of page content that is required by the system in respect of each page of the publication to be digitally printed. Conveniently, an email notification may be periodically communicated to each of the viral contributors providing updates regarding publications for which new page content is currently required for submission by viral contributors in the network, or, upcoming publication for which contributions from viral contributors will be required to assist in back-end production. The step of communicating the structure learning plan and prescribed parameters to the viral contributors is represented by block (310) in FIG. 3.

The central server (100) is configured to assist in automating coordination and management of the production and uploading of page content submissions from the viral contributors, and, to provide visibility to all participating viral contributors regarding the status of the page content available for any given publication. For instance, the central server may be programmed to automatically, (i) monitor the number of page content submissions that are received in respect of each page of the publication; (ii) periodically update the Web site to indicate the number of page content submissions received from viral contributors in respect of each page of the publication; (iii) and, where a threshold number of submissions have been received from viral contributors in respect of a given page of the publication, communicating a notice that no further page content submissions are required in respect of the specific page of the publication. Furthermore, where there is an imbalance in the number of page content submissions received in respect of certain pages of the publication, the central server may be programmed to automatically issue a notification to viral contributors offering incentives for producing and uploading page content in respect of less popular pages of the publication. Such incentives may include for instance offering a higher royalty amount to viral contributors for page content that is selected for use by customers in respect of specific pages of the publication. When a predetermined threshold number of page content options have been produced by the viral contributors in respect of each page of the publication, the central server (100) is automated to restrict any further upload access from the viral contributors and will communicate a notification to all viral contributors that no further participation is required in respect of the particular publication.

The specific mechanics by which newly produced page content is uploaded to the central server (100) need not be discussed in great detail as it would be appreciated that any suitable number of existing software interfaces can be readily configured for usage between the central server (100) and the end-user terminals (110) operable by the viral contributors to upload the materials. All page content submissions that are uploaded to the central server (100) are stored in the database system (150) running on the central server and are indexed for future referencing and retrieval. Such content is able to be recycled for use in other future publications. The step of receiving in the central server (100) page content produced by viral contributors is represented by block (320) in FIG. 3.

The central server (100) is also configured to maintain an updated record of the activity history of each viral contributor. The activity history may include details of the number of page content submissions that have been uploaded by each viral contributor, the percentage of page content submissions produced by each viral contributor that have been accepted for presentation as a page content option for user-selection, details of the publications and topics that each viral contributor has contributed to, royalties paid to each viral contributor, the frequency and regularity of participation of each viral contributor over time and so on. This information may be useful to both the administrator of the system as well as the individual viral contributor. From the perspective of the administrator, the recorded activity history is useful in terms of (i) identifying relatively active and valuable contributors to the system whereby incentives and inducements may be provided to ensure further ongoing participation, and, (ii) identifying less active contributors to the system and terminating further involvement where the quality and/or quantity of submissions are unsatisfactory. From the perspective of the individual viral contributors, the stored information provides useful feedback for professional development including an indication of the perceived quality and popularity of their work and whether changes or improvement to the style, quality or content of the writing may be warranted.

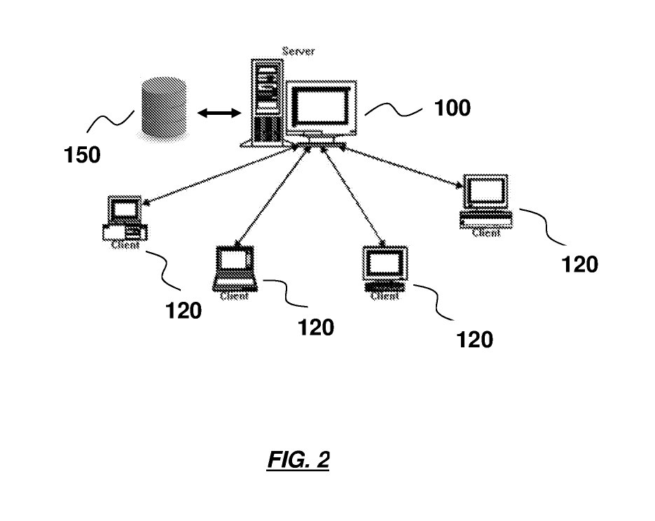

In this embodiment a front-end of the computerised system is provided comprising a user-interactive Web site accessible by customers via Web browser software running on end-user terminals (120) such as laptops, desktops and smartphone device browsers for instance. As shown in FIG. 2, the end-user terminals (120) operable buy the customers are communicably connected to the central server (100) and database (150). The Web site includes a customer interface having an interactive menu which allows customers to browse through a listing of publications that are available for page content personalisation. The interactive menu allows for browsing by both educational subject categories (e.g. mathematics, chemistry, physics, modern history, English etc.) as well as specific topics within each education subject category. For instance, under the educational subject category “mathematics”, there may be specific topics provided such as “algebra”, “geometry”, “statistics” and so on, or, where the educational subject category is “modern history”, there may be specific topics within this subject category including for instance “French revolution”, “American civil war”, “World war II” and so on. As with the case of the back-end pre-printing Web interface for access by the viral contributors, the front-end Web site system software and hardware is similarly hosted and run from the central server for simplicity and convenience. The step of presenting via the interactive Web interface page content options for customer selection to personalise each page of the publication is represented by block (330) in FIG. 3.

When the customer has selected a specific topic of interest via the interactive menu, the Web site is configured to display a layout of the pages of the selected publication based on the predetermined structured learning plan defined for that particular topic. A menu of page content options which may be selected for personalisation of each page is also presented to the customer in respect of the selected publication. To assist the customer in making a selection of page content for any given page, an interactive icon or hypertext link is associated with each of the page content options displayed on the Web site which when activated enables the customer to view further details of the viral contributor that authored the page content option on display. For instance, such further details could include the activity history of the viral contributor, the number of times customers have selected page content options authored by that particular viral contributor, a summary of the educational topics that the viral contributor has contributed page content options for selection in other publications in the past. Furthermore, the interactive menu of page content options could also be programmed to allow sorting of the page content options based upon the popularity of the page content option by other customers, the popularity of the viral contributor that authored the page content option, the age of the page content option including when it was first uploaded in to the computerised system, and so on.

As the customer makes selections of page content options for each page in the publication, the selections are recorded in a database record of customer the central server for future reference should the customer wish to order additional digital prints of the same publication and page selections. When no further page content selections are required to be made by the customer, the Web site is configured for allowing the customer to preview a final rendering of the publication layout containing all the selected page content options. If any changes or amendments are required, the customer has the option of altering the selection for a given page. If no changes are required and the final publication layout is decided, the information is placed in an order queue managed by central server whereby a digital printing system will print a hardcopy of the publication in accordance with the customer's personalised specification and ship the hardcopy publication to the customer. The step of the central server receiving customer selections of page content options for each page of the publication to be printed is represented by block (340) in FIG. 3. The step of printing and shipping the personalised publication to the customer is represented by block (350) in FIG. 3.

In addition to the actual selected educational content being printed in the pages of the publication other information may also printed on pages. For instance, the name of the viral contributor responsible for authoring the selected page content for each page is printed on the relevant pages. In addition to a fee being charged to customers for the cost of purchasing the personalised publications, fees are also charged to third-parties for the inclusion of advertising in the printed publications. Moreover, by maintaining historical records in the central server of the purchase behavior of customers as well as the page content selection history of customers, this historical customer activity information can be utilised by the central server to automatically allocate targeted advertising for inclusion of digitally printed publications.

In other embodiments of the present invention, the above-described systems and methods may be applicable and conveniently utilised in the context of bespoke printing of travel guides, maps and the like. In particular, the problem associated with existing travel guides and maps is that they will often contain an over-abundance of information concerning a particularly destination that may be irrelevant to the traveler. For instance, if a traveler is intending to only travel to one particular city within a large country to be visited, the traveler does not require the additional information regarding other cities within that country the inclusion of which makes the printed publication unduly heavy and cumbersome to carry. Accordingly, in this context a Web interface could be provided which would allow customers to select only page content relevant to the specific city or specific location of interest to the customer's travel plans. Furthermore, travelers have grown more reliant upon the usage of online map services for assistance when travelling in a foreign country. However, as it is not always convenient, practical or affordable for the traveler to have access to the Internet, such map services cannot always be relied upon. Accordingly, a traveler is able to print a physical and tangible bespoke map booklet utilising the personalised pagination features provided by embodiments of the present invention. The accessibility of bespoke personalised paginated publications is not only available in seeking to address such problems, but is also now relatively affordable, expedient to produce and offers diversity of choice in content by virtue of the novel utilisation of a network of viral contributors to generate page content options.

In certain embodiments of the present invention, the system may be configured to automatically provide a royalty to viral contributor in response to page content produced by the viral contributor being selected by a user of the system to personalise pages of a bespoke publication. The amount of the royalty that is paid to the viral contributor may be specifically agreed upon between the viral contributor and an administrator of the system, may comprise a fixed amount per page that is selected, and/or, may dynamically vary based upon a variety of factors at any given time including for instance, the size of the page content selected, the subject matter of the page content selected, the popularity of the viral contributor (e.g. how often any page content produced by the contributor is selected), the popularity of the specific page content that has been selected (e.g. how often the specific selected page content has been selected), how much revenue the contributor's content has generated for the system over a predetermined length of time, the length of time that the viral contributor has participated in the system and so on. Predetermined amounts of the royalties that are payable in response to the selection of page content may be recorded in a memory store of the system that is accessible by the central server (100), The central server (100) may be programmed to interface with any suitable electronic payments system to effect payment of the royalty to the viral contributor for instance at a predetermined time, or, at the point of sale of the page content.

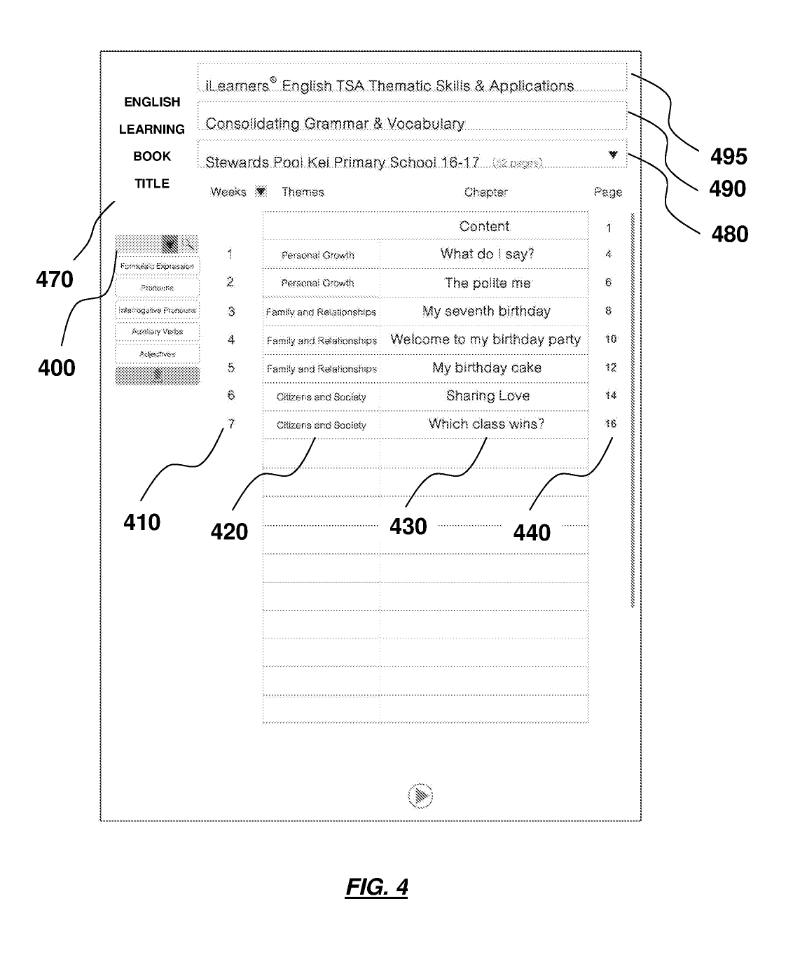

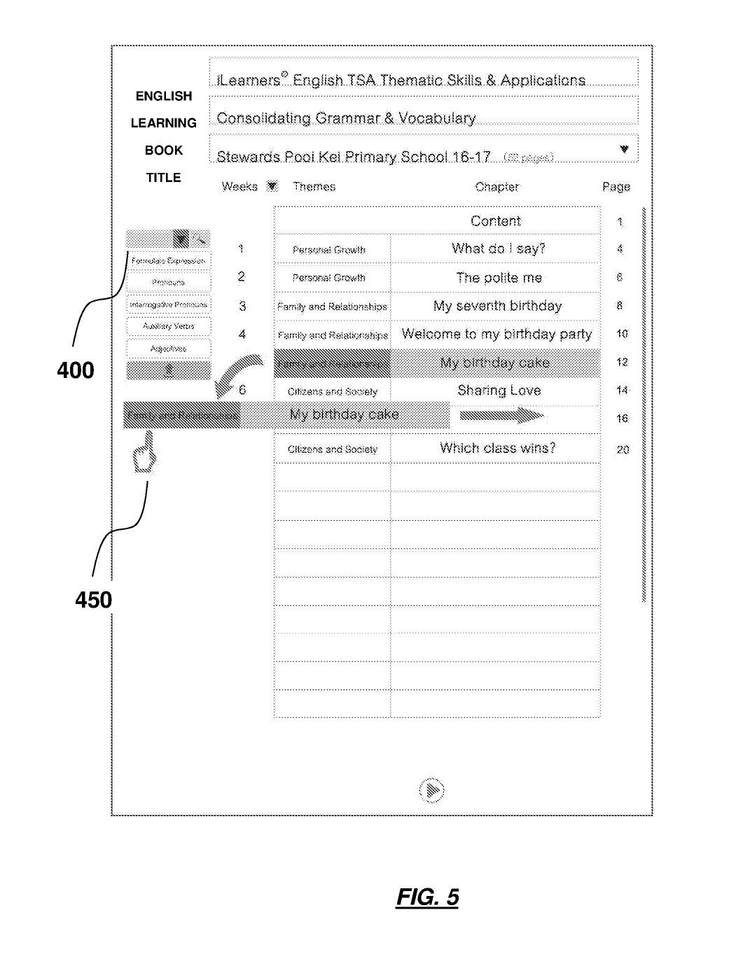

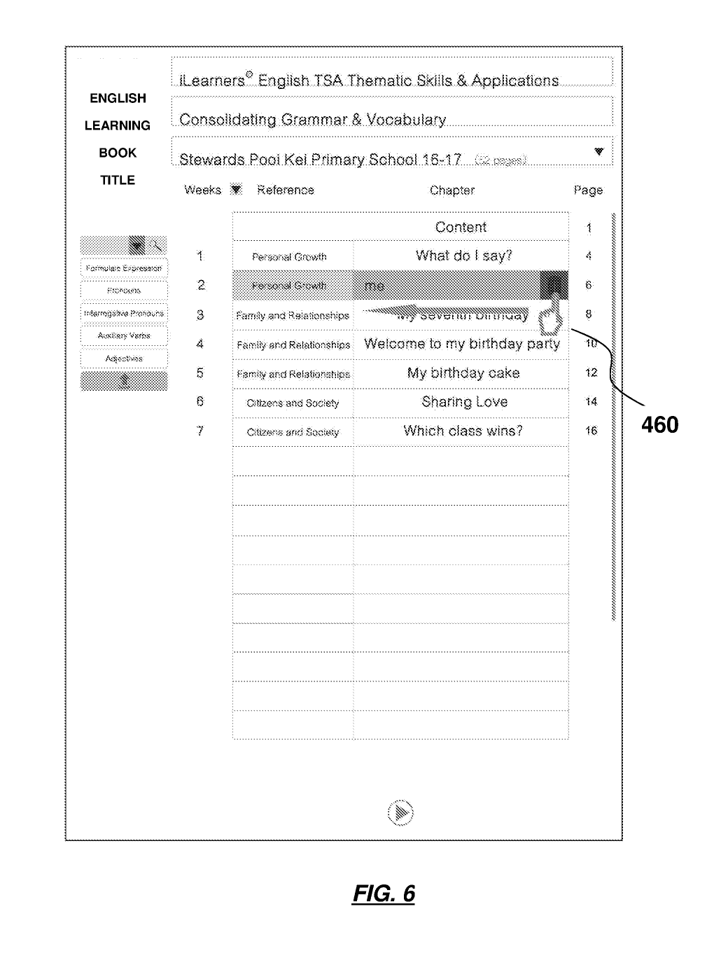

FIGS. 4 to 7 show example screenshots of an interactive user-interface application via which a user may personalise pages of a publication in accordance with an embodiment of the present invention. The user interface may be implemented for instance by downloading a software application in to the memory of a personal computer, smartphone, tablet-type device and the software application being executable by the processor unit of the personal computer, smartphone, tablet-type device to display. In FIG. 4 the user interface is shown being used for personalisation of an educational publication containing learning exercises. The user interface displays a title of the publication (495), a subheading of the publication (490), the name of the school which the publication is directed to (480) and a thumbnail image of the publication cover-page (470). The user interface also provides a searching tool (400) to allow keyword searching of page content that has been produced by freelance contributors within the system. The user-interface also displays an indication of the suggested weekly order (410) in which a lesson and learning exercises are to be studied/performed by the user, the theme (420) of the lesson and learning exercises to be studied/performed by the user in each week, page content within each theme (430), and the page numbers (440) of each page content as it will be displayed in the finished publication. In FIG. 5. it is shown that a user may, via the user-interface, selectably edit the order in which page content within the publication is presented by simply “dragging” icons representing the relevant page-content to different positions within the publication listing, as shown. In this example, the icon representing certain page content initially configured for display at page 12 of the publication is shifted (450) further down the list so that it is now configured for presentation at page 16 of the publication. The system is configured to automatically re-number the page content in response to the user shifting and re-ordering the page content in this manner. In FIG. 6 it is shown that a user may delete page content (460) form the publication via the user-interface for as shown. In this embodiment, in response to deletion of the page content, the system is configured to automatically cancel any royalty payment allocated to the content contributor due to early selection of such page content.

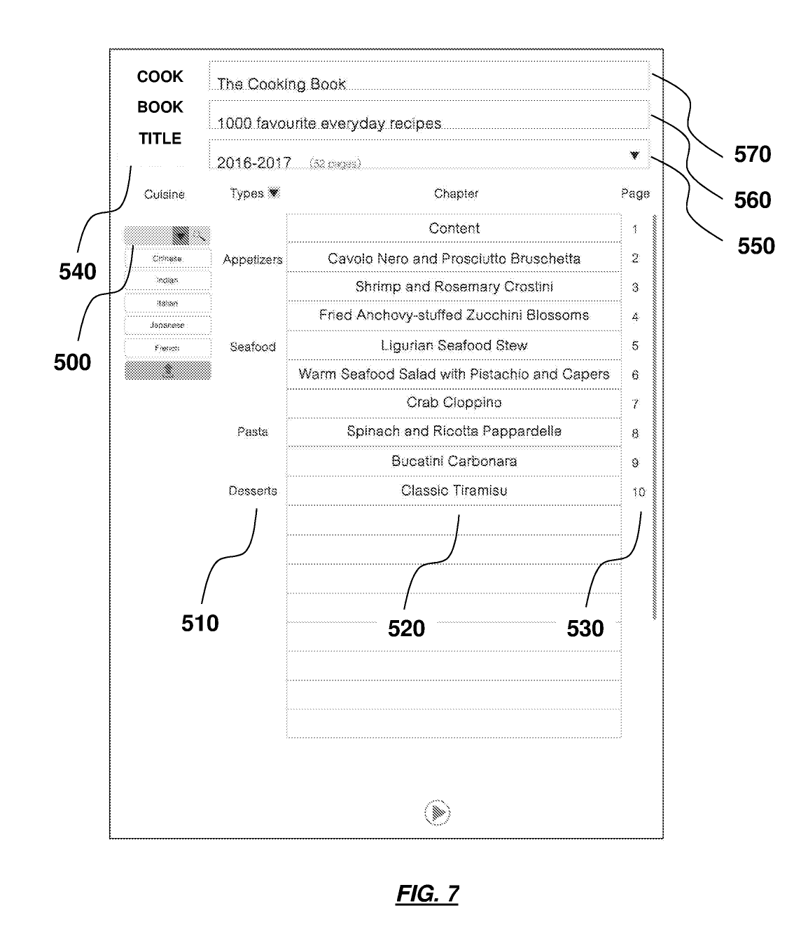

FIG. 7 shows a further example embodiment of the system, this time utilised for personalising a recipe book. In this embodiment, the title (570), subheading (560) and edition (550) are displayed together with a thumbnail image of the cover-page (540). A keyword searching tool (500) is also provided to search for page content as required by a user. The page content (520) is ordered by reference to cuisine types (510) which in this example includes appetizers, seafood, pasta and desserts. The page numbers (530) of the selected page contents are also displayed. As described above, the user is able to edit the order in which the page content is displayed in the finished printed publication via the user interface. In this embodiment, the order of display of the individual page contents (520) within any given cuisine type (510) can be edited, and/or, the order of display of the cuisine types (510) themselves can also be edited by the user using drag and drop or other touchscreen control gestures to effect desired edits of the publication.

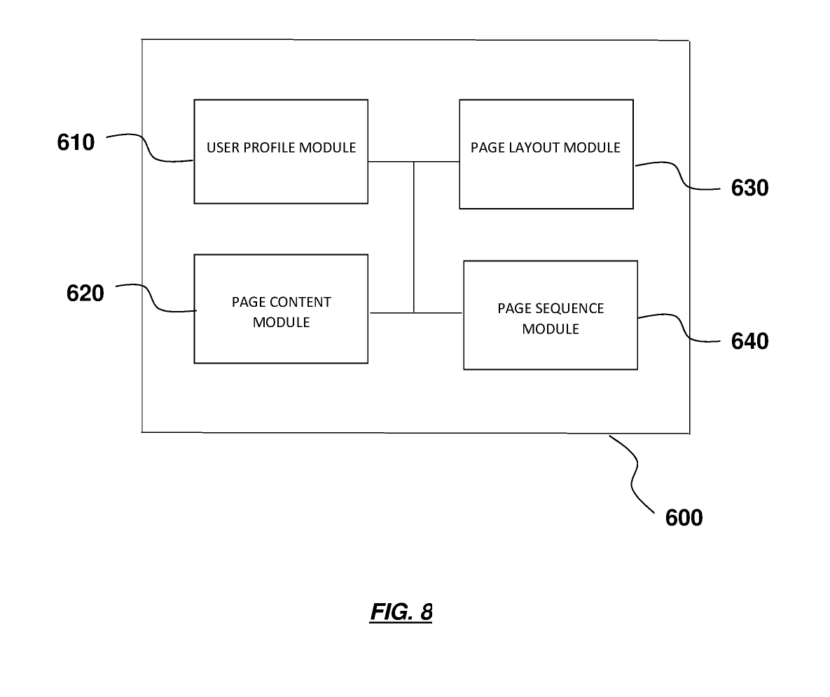

With reference to FIGS. 8-12 of the drawings, a further embodiment of the present invention will now be described comprising a computerised system (600) for customising page content of pages of a publication for digital printing. By way of example, the publication may comprise an illustrated story book for children having a fixed page content associated with each page of the illustrated story book in the form of an image or graphic. The computerised system (600) of this embodiment allows for the text displayed on each page of the illustrated story book to be customised by reference to a user profile of the target user of the illustrated story book so that the page content displayed on each page of the illustrated story book are age and language appropriate to the target user. Specifically, each page of the illustrated story book includes a “fixed” pre-set image/graphics page content positioned on each page which remains the same whilst text page content on each page is able to be customised for each page to accompany the fixed image/graphic page content displayed thereon. It should be noted that the term “fixed” does not necessarily mean that the position and format of the image/graphic as displayed on each page remains the same, but rather, the same general an image/graphic is always associated with a particular page of the story book for display on the page of the story book in combination with different possible text variations. Whilst example implementation of this embodiment of the present invention is described in relation to customisation of an illustrated story book, it would be readily understood and appreciated that this is merely to illustrate the functional operation of the embodiment and it is envisaged that the pages of any type of publication may be similarly customised according to the broad principles of operation described herein. For instance, such other publications may include school textbooks, advertising or marketing booklets and so on.

This present embodiment is operable using a computerised system (600) comprising a user profile module (610), a page content module (620), a page layout module (630) and a page sequence module (640) that are operably interconnected together. Any one of the features of the embodiment described herein referred to as a “module” may be implemented in software for execution by various types of processors. An identified module of executable code may, for instance, comprise one or more physical or logical blocks of computer instructions which may, for instance, be organised as an object, procedure, function, or algorithm. The identified blocks of computer instructions need not be physically located together, but may comprise disparate instructions stored in different locations which, when joined logically together, comprise the module and achieve the stated purpose for the module. A module may also be implemented as a hardware circuit comprising custom circuits or gate arrays, off-the-shelf semiconductors such as logic chips, transistors, or other discrete components. A module may also be implemented in programmable hardware devices such as field programmable gate arrays, programmable array logic, programmable logic devices or the like. A module of executable code may comprise a single instruction, multiple instructions, and may be distributed over several different code segments, among different programs, and across several discrete memory devices. Similarly, operational data may be identified and illustrated herein within modules, and may be embodied in any suitable form and organised within any suitable type of data structure. The operational data may be collected as a single data set, or may be distributed over different locations including over different storage devices, and may exist, at least partially, merely as electronic signals on a system or network. Furthermore, each of these “modules” may typically be comprised by separate computer devices having a processor device, a data store device, an input device and an output device. The modules may be operable using physically separate computer devices or may be integrally provided within a single computer device.

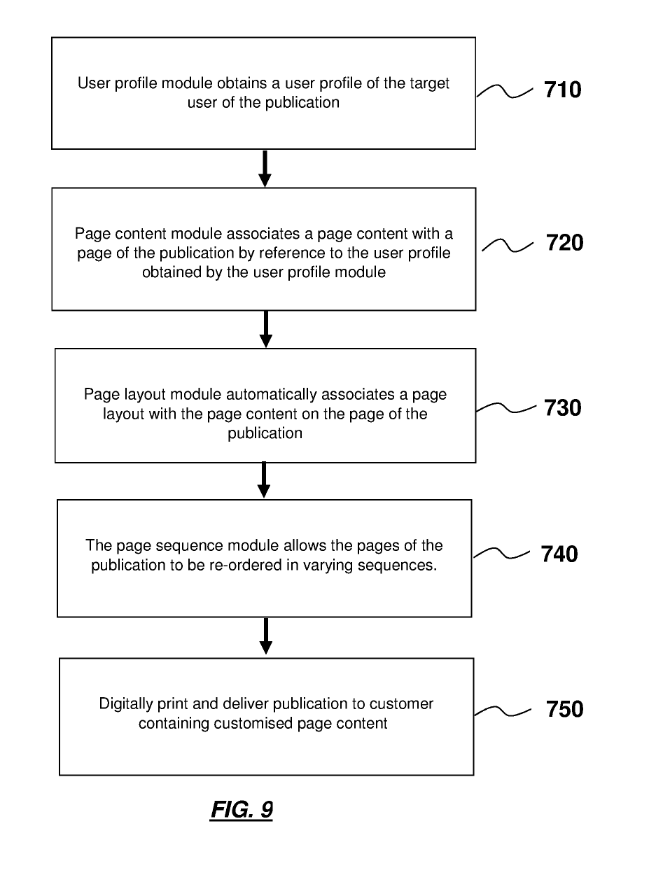

The user profile module (610) is configured for obtaining a user profile of the target user of the illustrated story book. This step is represented by block (710) in FIG. 9. This is important as the ability to customise each page of the illustrated story book with age and language appropriate text content accompanying the illustrations ensures that the target user will better comprehend, understand and learn from the illustrated story book. The user profile comprises information indicative of one or more characteristics of the target user of the publication—for instance, an age, a gender, and a language ability of the target user. When the computerised system (600) of this embodiment is applied to customisation of other types of publications, it may be appropriate for the user profile to comprise information indicative of other characteristics of the target user such as gender, sexuality, geographic location, ethnicity, nationality, socio-economic status, religious affiliation, sporting affiliation, political affiliation, educational institution affiliation, occupation, health status, and consumer purchase behaviour of the target user, amongst other things.

The information indicative of the characteristics of the target user may be obtained by the user profile module (610) in any number of ways. For instance, the information may be manually entered into the computerised system (600) by the user via an input interface such as a keyboard, microphone, or graphical user interface of the user profile module (610). Alternately, and more conveniently, user profile information may be stored in a database of the user profile module (610) and may be automatically retrieved by the user profile module (610) as required.

In response to the user profile module (610) obtaining the user profile information of the target user, thereafter, the page content module (620) associates a text-based page content with each of the pages of the illustrated story book by reference to the obtained user profile of the target user. This step is represented by block (720) in FIG. 9. As such each of the pages of the illustrated story book will now have a text-based page content as well as a fixed image/graphic based page content associated therewith. The text-based page content that may be associated with each page of the illustrated story book could be manually created by a user for instance by simply typing in text into the computerised system (600) via a keyboard operably connected with the page content module (620) of the computerised system (600). The computerised system (600) may include a computerised display for displaying representations of each page of the illustrated story book and for allowing a user to navigate amongst the different pages of the illustrated story book, for instance by scrolling through the different pages on an electronic display interface of the computerised system (600). As the user scrolls through each page, the page content module (620) is configured to generated a pop-up window prompting the user to commence typing in of customised text content for association with respective pages, and whereby as the text is typed in, the text is displayed within the pop-up window disposed on the electronic display of the computerised system (600). Once the customised text has been entered into the computerised system (600) for associated with each page, the information relating to the customised text page content for each page may be saved in a data store of the page content module (620).

Alternatively, the page content module (620) may be configured for automatically generating page content for association with each page of the illustrated story book by reference to the user profile obtained by the user profile module (610). For instance, a plurality of predefined text-based page contents may be stored in the data store of the page content module (620) with each of the different predefined text-based page contents being suitably customised for target users of different ages and of different language backgrounds. The page content module (620) is further configured to run a computer program thereon comprising computer executable instructions for implementing a matching algorithm for identifying and associating the most suitable predefined text-based page contents for each page of the illustrated story book by reference to the user profile of the target user of the illustrated story book. By way of example, in determining a match between the different predefined text-based page contents and the pages of the illustrated story book, the matching algorithm may compare specific features of each different text-based page content such as vocabulary type, word count, grammar pattern, font style, and language type, against specific characteristic of the user profile of the target user such as age, language of the target user. The intelligence of the matching algorithm that is used in this process may be based upon collected proprietary or non-proprietary historical data of useage patterns of customised publications and related user profile information. Such collected historical useage data may assist in enhancing the intelligence of the matching algorithm in terms of predicting an appropriate level of complexity of the text, an appropriate level of vocabulary of the text, an appropriate level of grammar pattern of the text, and an appropriate language of the text-based page content that is associated with any given page of the illustrated story book.

The page layout module (620) is configured for associating one page layout from amongst a plurality of predefined page layouts with the page content on the at least one page of the publication. This step is represented by block (730) in FIG. 9. The page layout module (620) may be configured to perform this function by either (i) running a computer program comprising computer executable instructions for implementing a matching algorithm for matching a suitable page layout with the page content associated with each given page, or, (ii) by allowing a user to simply manually select the desired page layout via an input interface of the page layout module (620). The matching algorithm will select the most suitable of the predefined page layout options based on such factors as the amount of text based content associated with each page of the illustrated story book, the amount of image/graphics based page content associated with each page the orientation of the page and so on. Conveniently, the page layout associated with each page of the illustrated story book will automatically arrange the text based page content and fixed image/graphic page content on each page of the illustrated story book without requiring the use of complicated graphics software. This embodiment may also include a page sequence module to allow the user to control the page sequence of pages of the publication, for instance in accordance with customised pagination process of the earlier-described embodiment herein. This step is represented by block (740) in FIG. 9. Once the step of page sequence editing is completed, if at all required, then the customised publication may be readily digitally printed via any digital printer operably connected with the computerised system. This step is represented by block (750) in FIG. 9.

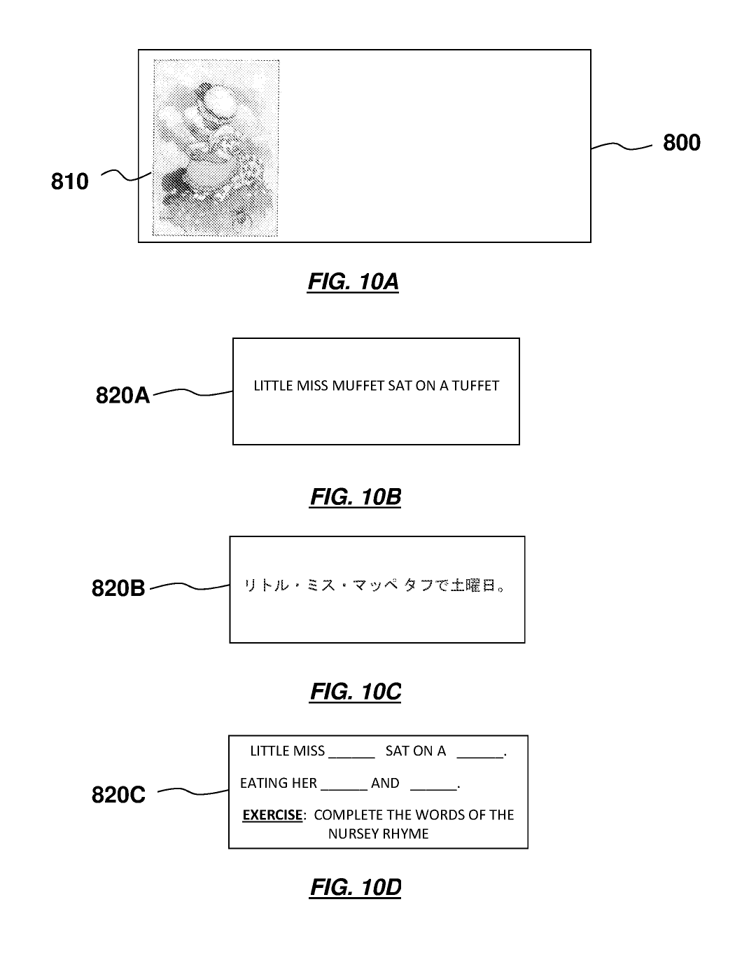

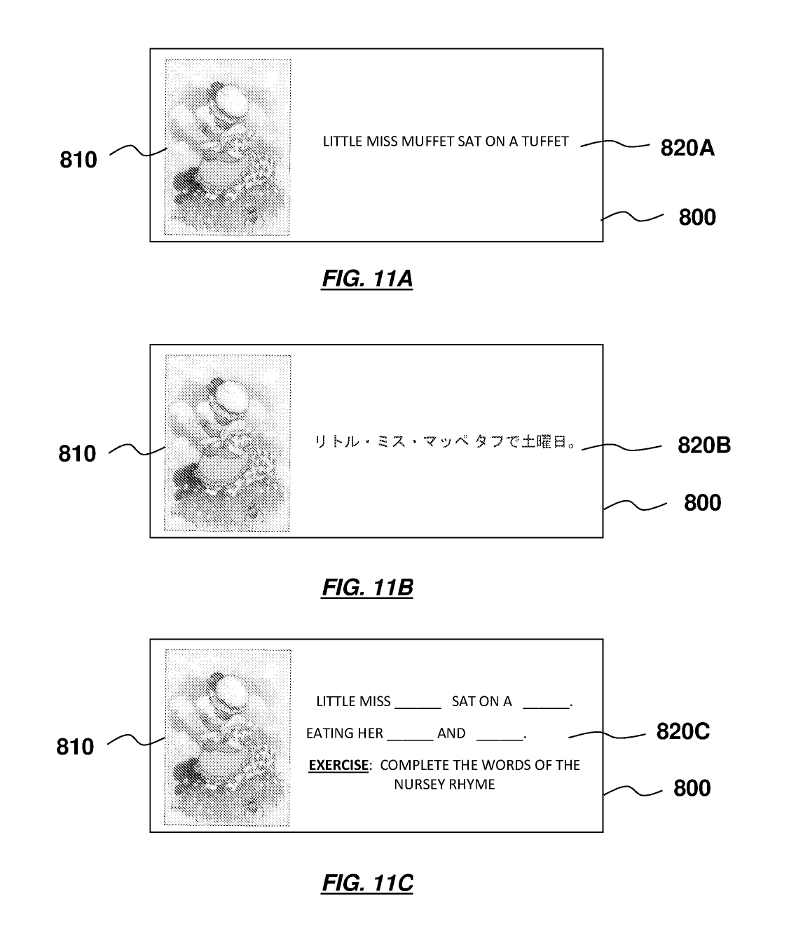

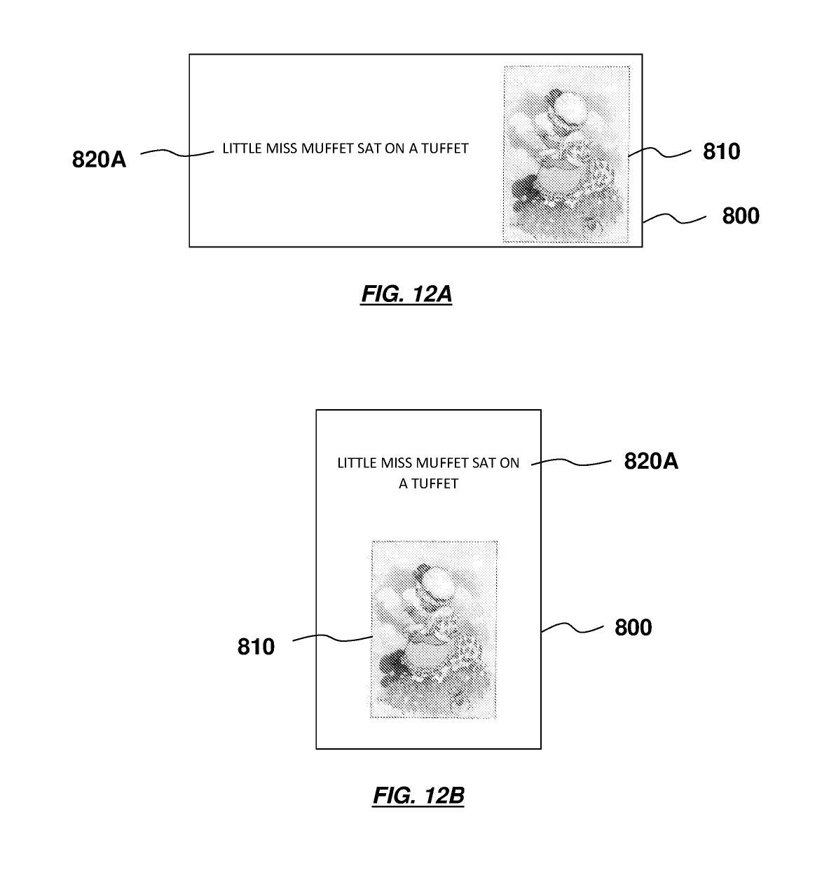

For ease of illustration of the above process steps in customising of the pages of an illustrated story book, FIG. 10A depicts a representation of one page of the illustrated story book having pre-set image (810) arranged in position for display thereon. FIGS. 10B-10C represent varying text-based page content options which may be associated with the page (800) depending upon the particular user profile or the target user. In this case, the text page content shown in FIG. 10B is a relatively simple English sentence of the nursey rhyme “Little Miss Muffet sat on a tuffet” (820A). In comparison, an alternative text-based page content which may be associated with the page (800) comprises the same sentence of the nursery rhyme but in Japanese characters (820B), whilst FIG. 10D represents depicts a relatively complex “exercise” type text-based page content which is intended to test the skills of a child in completing the words of the nursery rhyme (820C). Turning now to FIGS. 11A-11C, 3 different customised versions of the page (800) of the illustrated story book are depicted with each of the different text-based page options of FIGS. 10B-10D arranged in combination with the pre-set page content (810) on the page (800) in accordance with one page layout option. FIGS. 12A and 12B depict the page of the illustrated story book with alternate page layout arrangements of the text-based page content arranged relative to the pre-set image/graphics based page content.

Also in this embodiment, information representing each customised page of the illustrated story book is stored in a database of the page content module which can then be made available for re-use by the same user again in future, or which may be shared with other users via the computerised system (600) for use in the customised pagination of other books of other users. Such newly generated page content may be tagged and indexing within the computerised system (600) for ease of identification and retrieval in the pagination process. Information relating to the suitability of the page for particular target user profiles may be used to tag each page.

As mentioned above, the application of this embodiment for customisation of an illustrated story book is merely one example of the application of this embodiment. In alternate embodiments, other publications such as school text-books, class notes, worksheets, exam papers, exercise books, advertising and marketing booklets, and so on may similarly be customised in accordance with similar principles described above. In yet a further embodiment, the computerised system may enable customised images/graphics to be associated with each page of a publication in substitute for or in addition to any pre-existing image/graphics associated with the given pages of the publication. Such customised images/graphics may for instance include a personalised photograph taken by the user using a smartphone and uploaded in to the page content module of the computerised system using a software app running on the smartphone. In the context of educational learning, an advantage in being able to associate a personalised image/graphic with a page of an educational publication is that the customiser of the publication is able to convey a visually provocative statement in relation to a particular lesson which may generate a greater degree of discussion and reflection than may ordinarily be the case. Such a response is perceived to assist in enhancing the learning process. Yet other potential applications of this embodiment of the present invention may be for recycling aspects of the page content of newspapers, magazines, travel-related publications, cooking and culinary-related publications, as well as eulogies for funeral services.

In certain embodiments of the present invention, the computerised system may include a user interface via which users may interactively communicate with each other (e.g. via messaging on an online discussion forum) so as to share comments, feedback, reviews and suggestions relating to the quality, nature, language accuracy of the page content received in to the computerised system by freelance content providers and which are available for selection to customise a publication. The user interface for facilitating such interactive communication between users may comprise a stand-alone user interface such as an online discussion forum, or, may be integrated into the Web site user interface via which a user may select each page content. For instance, an interactive icon or hypertext link may be associated with each of the page content options displayed on the Web site user interface which when activated enables the customer to view further details of the viral contributor that authored the page content option on display, or, view recorded comments, feedback and reviews of each page content in terms of the quality, nature, language accuracy of the page content, popularity of the page content option by other users, the popularity of the viral contributor that authored the page content option, the age of the page content option including when it was first uploaded in to the computerised system, and so on, as perceived by other users. For instance, clicking on the interactive icon or link may cause a new Web page to open or a pop-up to activate in which the further information may be displayed. The computerised system may for instance allow users to provide ratings from 1-10 for each available page content in respect of the quality, nature, language accuracy of each available page content. Such comments, feedback, reviews and/or ratings may also be displayed directly adjacent to each page content on the Web site user interface for immediate viewing by users without needing to click on an interactive icon or link.

Those skilled in the art will appreciate that the invention described herein is susceptible to variations and modifications other than those specifically described without departing from the scope of the invention. All such variations and modification which become apparent to persons skilled in the art, should be considered to fall within the spirit and scope of the invention as broadly hereinbefore described. It is to be understood that the invention includes all such variations and modifications. The invention also includes all of the steps and features, referred or indicated in the specification, individually or collectively, and any and all combinations of any two or more of said steps or features.

The reference to any prior art in this specification is not, and should not be taken as, an acknowledgment or any form of suggestion that that prior art forms part of the common general knowledge.

1. A method of providing page content options for user-selection to personalise pages of a publication for digital printing, the method being operable using a computerised system, and the method including the steps of:
(i) prescribing parameters for page content associated with pages of the publication to be digitally printed;
(ii) communicating the prescribed page content parameters to a plurality of content contributors; and
(iii) receiving page content produced by the plurality of content contributors in response to the prescribed parameters communicated thereto;
wherein, the received page content produced by the plurality of content contributors is able to be presented as page content options for user-selection to personalise pages of the publication for digital printing.

2. The method as claimed in claim 1 wherein the plurality of content contributors comprise freelance content contributors.

3. The method as claimed in claim 1 including providing an online interactive menu interface via which a user is able to select form the page content options to personalise pages of the publication to be digitally published.

4. The method as claimed in claim 1 wherein the publication includes an educational publication and the page content associated with pages of the publication includes at least one of an essay, a case study, lecture notes, learning exercises and an assessment.

5. The method as claimed in claim 4 wherein the prescribed parameters of the page content associated with the pages of the publication include a learning objective of the at least one of the essay, the case study, the lecture notes, the learning exercises and the assessment included on each page.

6. The method as claimed in claim 1 wherein when a page content option is selected for inclusion as page content of a page of the publication, the content contributor that produced the selected page content option is attributed on the page of the publication.

7. The method as claimed in claim 1 wherein when a page content option is selected for inclusion as page content of a page of the publication, the content contributor that produced the selected page content option is rewarded with a royalty.

8. The method as claimed in claim 1 including a step of assessing whether page content produced by the plurality of content contributors meets a predetermined screening criteria before presenting the page content option for user-selection.

9. The method as claimed in claim 1 including a step of selecting targeted advertising for inclusion in the publication to be digitally printed, the targeted advertising being selected for inclusion in the publication by reference to the page content options selected by the user.

10. The method as claimed in claim 1 including a step of automatically providing a content contributor with a royalty payment in response to page content produced by the content contributor being selected by the user for personalization of the publication.

11. A computerised system for use in providing page content options for user-selection to personalise pages of a publication for digital printing, the computerised system being configured for:
(i) prescribing parameters for page content associated with pages of the publication to be digitally printed;
(ii) communicating the prescribed page content parameters to a plurality of content contributors; and
(iii) receiving page content produced by the plurality of content contributors in response to the prescribed parameters communicated thereto;
wherein, the received page content produced by the plurality of content contributors is able to be presented as page content options for user-selection to personalise pages of the publication for digital printing.

12. The computerised system as claimed in claim 11 wherein the plurality of content contributors comprise freelance content contributors.

13. The computerised system as claimed in claims 11 configured for providing an online interactive menu interface via which a user is able to select form the page content options to personalise pages of the publication to be digitally published.

14. The computerised system as claimed in claim 11 wherein the publication includes an educational publication and the page content associated with pages of the publication includes at least one of an essay, a case study, lecture notes, learning exercises and an assessment.

15. The computerised system as claimed in claim 14 wherein the prescribed parameters of the page content associated with the pages of the publication include a learning objective of the at least one of the essay, the case study, the lecture notes, the learning exercises and the assessment.

16. The computerised system as claimed in claim 11 configured such that when a page content option is selected for inclusion as page content of a page of the publication, the content contributor that produced the selected page content option is attributed on the page of the publication.

17. The computerised system as claimed in claim 11 configured such that when a page content option is selected for inclusion as page content of a page of the publication, the content contributor that produced the selected page content option is rewarded with a royalty.

18. The computerised system as claimed in claim 11 configured to assess whether page content produced by the plurality of content contributors meets a predetermined screening criteria before presenting the page content option for user-selection.

19. The computerised system as claimed in claim 11 configured to include targeted advertising in the publication to be digitally printed, the targeted advertising being selected for inclusion in the publication by reference to the page content options selected by the user.

20. The computerised system as claimed in claim 11 configured to automatically provide a content contributor with a royalty payment in response to page content produced by the content contributor being selected by the user for personalization of the publication.

21-43. (cancelled)
